(19) United States
(12) Patent Application Publication
(10) Pub. No.: US 2015/0307337 A1
(43) Pub. Date: Oct. 29, 2015

(54) VEHICLE MOUNTED CRANE BOOM ASSEMBLY WITH A DIELECTRIC BOOM ARM

(71) Applicant: LINEPRO EQUIPMENT LTD., Abbotsford, (CA)

(72) Inventor: Larry EWERT, Abbotsford (CA)

(21) Appl. No.: 14/650,535

(22) PCT Filed: Dec. 9, 2013
(86) PCT No.: PCT/CA2013/050946

§ 371 Date: Jun. 8, 2015

Related U.S. Application Data
(60) Provisional application No. 61/734,916, filed on Dec. 7, 2012.
(60) Provisional application No. 61/884,990, filed on Sep. 30, 2013.
(60) Provisional application No. 61/884,993, filed on Sep. 30, 2013.

(51) Int. Cl. B66F 11/04

(52) U.S. Cl. CPC B66F 11/046

(57) ABSTRACT

A hydraulic boom assembly comprises a base and a first boom arm extending from the base. A second boom arm is pivotably coupled to the first boom arm. There is a hydraulic system for actuating the first boom arm between an extended position and a retracted position, and for pivoting the second boom arm. A work platform is coupled to the second boom arm. The work platform is provided with a brake mechanism that is independent of the hydraulic system for actuating the first boom arm and pivoting the second boom arm.

### BACKGROUND OF THE INVENTION

1. Field of the Invention

The present invention relates to a crane boom assembly and, in particular, to a crane boom assembly which is mounted on a vehicle and provided with a dielectric boom arm.

2. Description of the Related Art

U.S. Pat. No. 4,679,653, which issued to Pasquarette et al. on Jul. 14, 1987, discloses a crane boom assembly having three vertically articulating boom sections which swivel on a common turret for horizontal positioning. A third or outer one of the boom sections comprises telescoping booms with an outer boom thereof being constructed of a dielectric material such as fiberglass for carrying an electrically insulated man-lifting bucket at its outer end. A pair of hydraulic extension and retraction cylinders for the telescoping booms of the third boom section are both housed internally of the third boom section and are mechanically interconnected and hydraulically coupled in such a way that, upon extension of the third boom section, the fiberglass boom always extends first and, upon retraction of the third boom section, the fiberglass boom always retracts last. One of the booms of the third section utilizes an unusually long rod in connection with its hydraulic cylinder unit. The rod is supported against bending and twisting by a sliding support coupled in a lost motion connection with the fiberglass boom. A radio transmitter carried in the lifting bucket enables a workman to control all operating functions of the crane from the lifting bucket itself without creating an electrically conductive path to ground potential through control wires and cables.

There however remains a need for a dielectric boom arm which may be retrofitted to an existing crane boom assembly to provide a crane boom assembly with a dielectric boom arm.

### SUMMARY OF THE INVENTION

There is accordingly provided a hydraulic boom assembly with a base and a first boom arm extending from the base. A second boom arm is pivotably coupled to the first boom arm. There is a hydraulic system for actuating the first boom arm between an extended position and a retracted position, and for pivoting the second boom arm. A work platform is coupled to the second boom arm. The work platform is provided with a brake mechanism that is independent of the hydraulic system for actuating the first boom arm and pivoting the second boom arm. The second boom arm may be a side-stowed, dielectric boom arm. The second boom arm may be a stowed-under, dielectric boom arm. The first boom arm may be a telescopic boom arm.

There may be a hydraulic actuator near a proximal end of the second boom arm for pivoting the second boom arm relative to the first boom arm. The second boom arm may be pivotable between a stowed orientation through two hundred and seventy degrees to an upwardly extending vertical orientation when the first boom arm is horizontal. There may be a stop for inhibiting the second boom arm from pivoting in a direction away from the stowed orientation beyond the upwardly extending vertical orientation.

The hydraulic system may include a dump valve connected along a hydraulic circuit that provides hydraulic fluid to an actuator to pivot the first boom arm upward. The dump valve may be actuated to open when the second boom arm is in the upwardly extending vertical orientation and thereby inhibit the first boom arm from pivoting in a direction away from the stowed orientation beyond the upwardly extending vertical orientation.

The hydraulic system may include a dump valve connected along a hydraulic circuit that provides hydraulic fluid to an actuator to pivot the second boom arm in a direction away from the stowed orientation. The dump valve may be actuated to open when the second boom arm is in the upwardly extending vertical orientation and thereby inhibit the second boom arm from pivoting in a direction away from the stowed orientation beyond the upwardly extending vertical orientation.

The hydraulic system may include a dump valve connected along a hydraulic circuit that provides hydraulic fluid to an actuator in order to pivot the first boom arm downward. The dump valve may be actuated to open when the first boom arm is at a maximum operating radius and thereby inhibit the first boom arm from pivoting downward.

The hydraulic system may include a dump valve connected along a hydraulic circuit that provides hydraulic fluid to an actuator in order to extend the first boom arm. The dump valve may be actuated to open when the first boom arm is at a maximum operating radius and thereby inhibit the first boom arm from extending.

There is also provided a vehicle with a hydraulic boom assembly. The hydraulic boom assembly comprises a base and a first boom arm extending from the base. A second boom arm is pivotably coupled to the first boom arm. There is a hydraulic system for actuating the first boom arm between an extended position and a retracted position, and for pivoting the second boom arm. There is a work platform coupled to the second boom arm. The work platform is provided with a brake mechanism that is independent of the hydraulic system for actuating the first boom arm and pivoting the second boom arm. The second boom arm may be a side-stowed, dielectric boom arm. The second boom arm may be a stowed-under, dielectric boom arm.

There is further provided an attachment for a boom assembly which comprises a first boom arm and a hydraulic system for actuating the first boom arm. The attachment comprises a dielectric boom arm which is pivotably couplable to the first boom arm. There is a hydraulic actuator near a proximal end of the dielectric boom arm for pivoting the dielectric boom arm relative to the first boom arm. The hydraulic actuator is connectable to the hydraulic system for actuating the first boom arm. There is a work platform coupled to the dielectric boom arm. The work platform is provided with a brake mechanism that is independent of the hydraulic actuator.

### BRIEF DESCRIPTIONS OF DRAWINGS

The invention will be more readily understood from the following description of the embodiments thereof given, by way of example only, with reference to the accompanying drawings, in which:

FIG. 1 is a perspective view showing an improved boom assembly mounted on a vehicle in a retracted or stowed position;

FIG. 2 is a perspective view of a dielectric boom arm and a work platform of the boom assembly of FIG. 1;

FIG. 3 is another perspective view of the dielectric boom arm and the work platform of the boom assembly of FIG. 1;

FIG. 4 is an elevation view of the boom assembly of FIG. 1 mounted on the vehicle in an extended position with the dielectric boom arm in a horizontal orientation;

FIG. 5A is an elevation view of the boom assembly and vehicle of FIG. 1 illustrating a range of motion of the dielectric boom arm;

FIG. 5B is an enlarged view of a portion of FIG. 5A showing a physical stop which stops pivoting of the dielectric boom arm past two hundred and seventy degrees;

FIG. 6 is an elevation view of the boom assembly of FIG. 1 illustrating a range of motion of the boom assembly;

FIG. 7 is an elevation view of the boom assembly and vehicle of FIG. 1 in an extended position with the dielectric boom arm in an upwardly extending vertical orientation adjacent a power line stanchion;

FIG. 8A is a schematic diagram of a hydraulic system of the boom assembly of FIG. 1 illustrating positions of dump valves when the dielectric boom arm is not in the upwardly extending vertical orientation;

FIG. 8B is a schematic diagram of the hydraulic system of the boom assembly of FIG. 1 illustrating positions of dump valves when the dielectric boom arm is in the upwardly extending vertical orientation;

FIG. 8C is a schematic diagram of the hydraulic system of the boom assembly of FIG. 1 illustrating positions of dump valves when a telescopic boom arm is at a maximum operating radius;

FIG. 9 is a simplified flowchart illustrating logic which controls motion of the telescopic boom arm of the boom assembly;

FIG. 10 is a simplified flowchart illustrating logic which controls motion of the dielectric boom arm of the boom assembly;

FIG. 11 is a perspective view showing a second embodiment of an improved boom assembly mounted on a vehicle in a retracted or stowed position;

FIG. 12 is a perspective view of a dielectric boom arm and a work platform of the boom assembly of FIG. 11;

FIG. 13 is another perspective view of the dielectric boom arm and the work platform of the boom assembly of FIG. 11;

FIG. 14 is an elevation view of the boom assembly of FIG. 11 mounted on the vehicle in an extended position with the dielectric boom arm in a horizontal orientation;

FIG. 15A is an elevation view of the boom assembly and vehicle of FIG. 11 illustrating a range of motion of the dielectric boom arm; and

FIG. 15B is an enlarged view of a portion of FIG. 15A showing a physical stop which stops pivoting of the dielectric boom arm past two hundred and seventy degrees.

### DESCRIPTIONS OF THE PREFERRED EMBODIMENTS

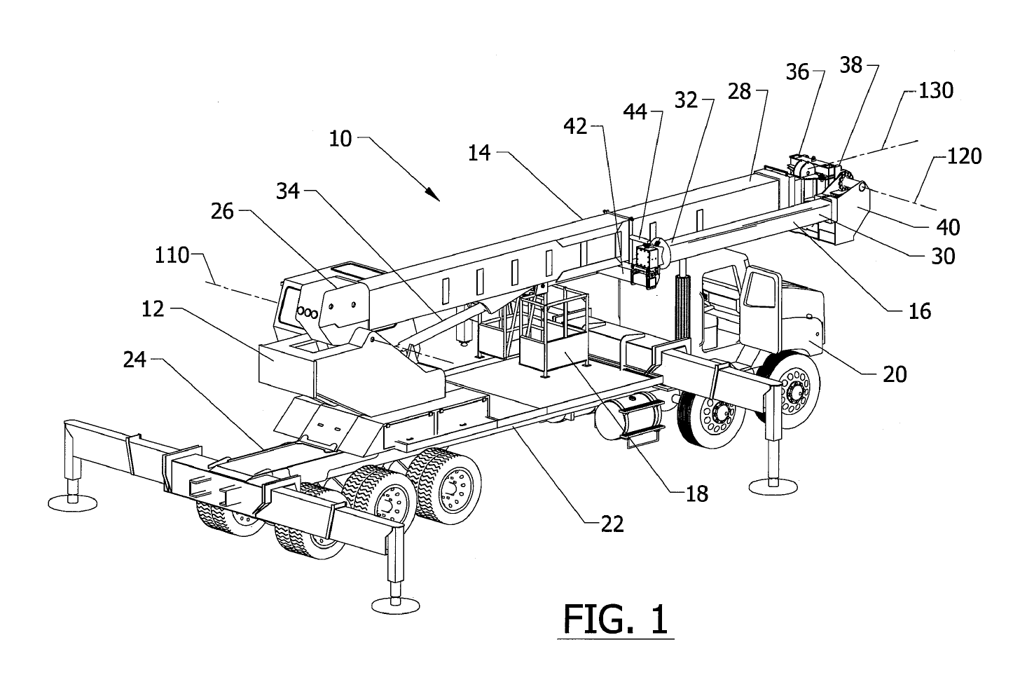

Referring to the drawings and first to FIG. 1, a boom assembly 10 is shown. The boom assembly 10 generally includes a base 12, a first boom arm which in this example is a telescopic boom arm 14, a second boom arm which in this example is a dielectric boom arm 16, and a work platform 18 which may also be referred to as a work bucket. The boom assembly 10 is mounted on a vehicle 20 and, in particular, the base 12 of the boom assembly is mounted on a flatbed 22 of the vehicle near a rear 24 thereof. The boom assembly 10 is rotatably mounted to the vehicle 20 in this example. However, in other examples, the boom assembly may be fixedly mounted on the vehicle.

The telescopic boom arm 14 has a proximal end 26, which is proximal relative to the base 12, and a distal end 28 which is distal relative to the base 12. Likewise the dielectric boom arm 16 has a proximal end 30, which is proximal relative to the distal end 28 of the telescopic boom arm 14, and a distal end 32 which is distal relative to the distal end 28 of the telescopic boom arm 14. The proximal end 26 of the telescopic boom arm 14 is pivotably coupled to the base 12 in a conventional manner and there is an actuator 34 which functions to pivot the telescopic boom arm 14 about a pivot axis 110. Hydraulic extension cylinders and cables within the telescopic boom arm 14 move the telescopic boom arm between an extended position and a retracted position in a conventional manner. There is a bracket 36 mounted on the telescopic boom arm 14 at the distal end 28 thereof. The bracket 36 supports a rotary actuator 38 which, in this example, is in the form of a helical hydraulic rotary actuator. The proximal end 30 of the dielectric boom arm 16 is coupled to an output drive (not shown) of the rotary actuator 38. The rotary actuator 38 imparts rotary motion to the dielectric boom arm 16 such that the dielectric boom arm is pivotable about a pivot axis 120 which is substantially perpendicular to a longitudinal axis 130 of the telescopic boom arm 14. The distal end 32 of the dielectric boom arm 16 is coupled to the work platform 18 by a yoke 42. A support arm 44 may be used to restrict movement of the dielectric boom arm 16 during transport.

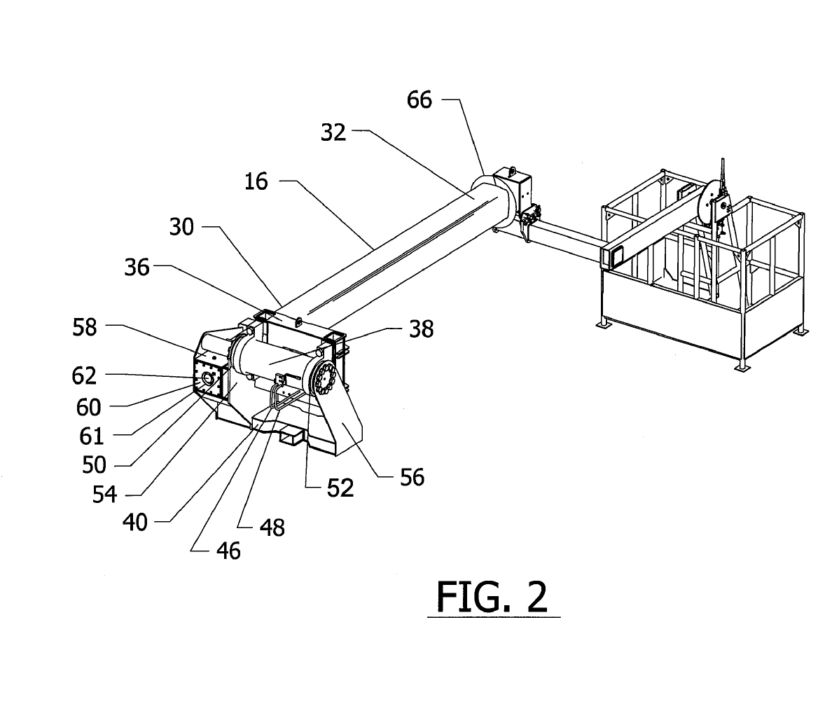

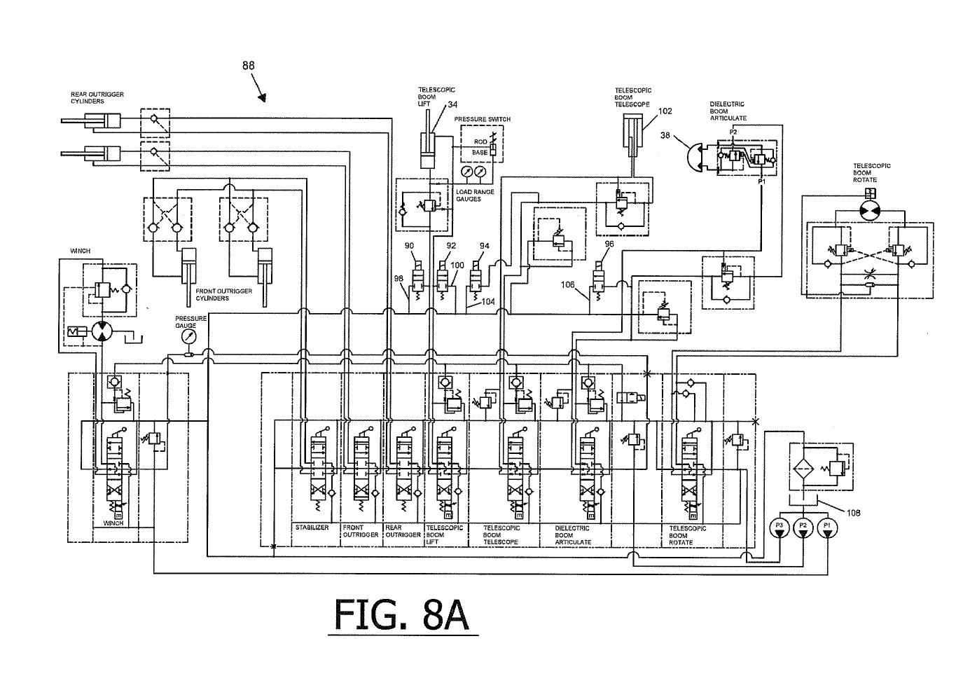

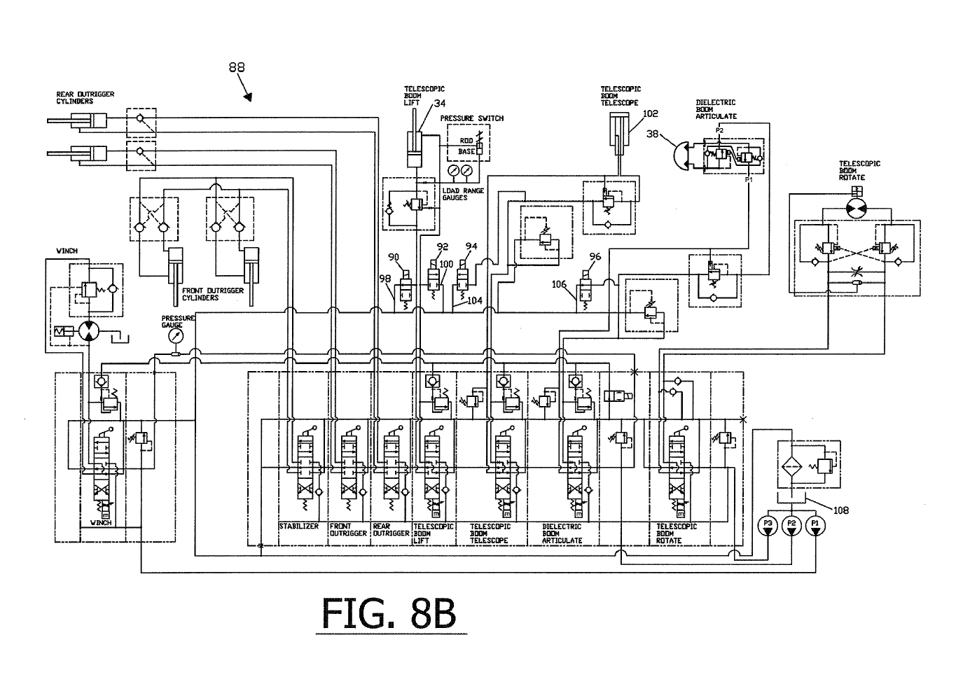

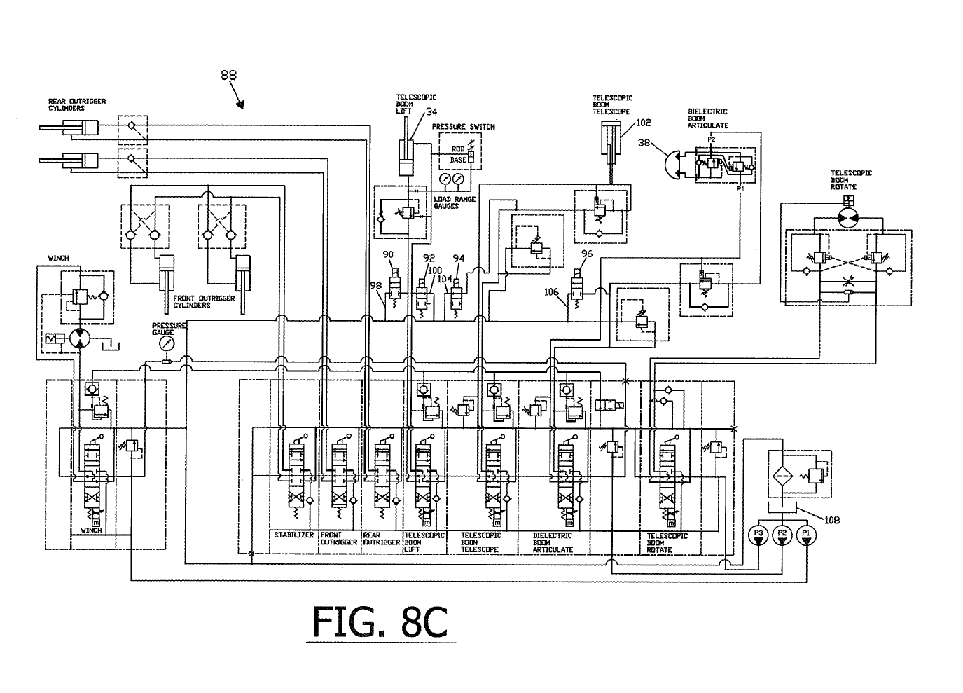

Referring now to FIG. 2, the rotary actuator 38 and a bracket 40 coupling the rotary actuator to the dielectric boom arm 16 are shown in greater detail. The rotary actuator 38 is independently controlled by pumping hydraulic fluid through hydraulic hoses 46 and 48. The hydraulic hoses 46 and 48 extend along the telescopic boom arm 14, shown in FIG. 1, when the telescopic boom arm 14 is in the extended position. The hydraulic hoses 46 and 48 retract into retractable hose reels (not shown) when the telescopic boom arm 14 is in the retracted position. The hydraulic hoses 46 and 48 are also connected to a directional control valve (not shown) and then to a hydraulic pump or hydraulic tank 108, shown in FIGS. 8A and 8C, on the vehicle 20 as is conventional.

The output drive of the rotary actuator 38 includes outer flanges 50 and 52 which are secured to corresponding flanges 54 and 56 of the bracket 40. The outer flanges 50 and 52 of the rotary actuator 38 impart motion to the bracket 40 and thereby impart motion to the dielectric boom arm 16. The bracket 40 also includes a socket 58 which receives the proximal end 30 of the dielectric boom arm 16. The socket 58 is provided with a window 60, of acrylic in this example, having an opening 61 for receiving a desiccant canister 62. The acrylic window 60 is releasably secured to the socket 58 by a bolted connection which compresses a gasket (not shown) to provide an environmentally resistant seal to inhibit ingress of dirt or moisture into an interior of the dielectric boom arm 16. The desiccant canister 62 may be releasably coupled to the acrylic window 60 by mechanical threading. The purpose of the desiccant canister 62 is to allow air inside the dielectric boom arm 16 to expand and compress as well as to remove moisture which may have entered the dielectric boom arm 16.

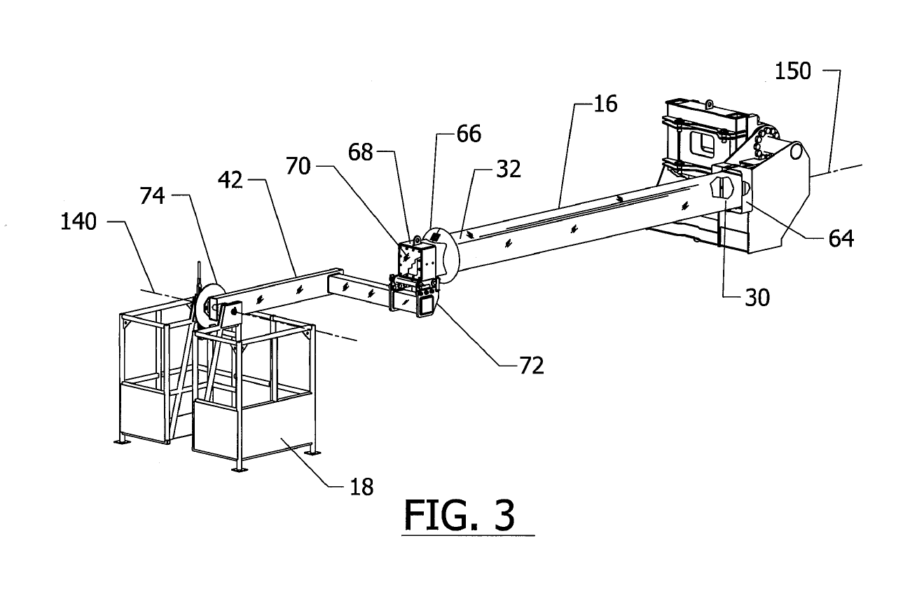

Referring now to FIG. 3, the dielectric boom arm 16 is dielectrically insulated from a conductive shield 64 at the proximal end 30 thereof to a gradient control device 66 at the distal end 32 thereof. The gradient control device 66 has a tapered cone shape with a sharp outer edge. The purpose of the gradient control device 66 is to restrict corona streamers from encroaching on an insulated portion of the dielectric boom arm 16. All conductive components mounted distally of the gradient control device 66 should be electrically bonded to the gradient control device but should not encroach on the gradient control device during operation of the dielectric boom arm 16.

There is a socket 68 at the distal end 32 of the dielectric boom arm 16. The socket 68 is provided with a window 70, of acrylic in this example, that is releasably secured to the socket 68 by a bolted connection which compresses a gasket (not shown) to provide an environmentally resistant seal. The acrylic window 70 allows for easy inspection of the interior of the dielectric boom arm 16. There is also a bracket 72 at the distal end 32 of the dielectric boom arm 16, where the bracket 72 couples to the socket 68. The yoke 42, which is an L-shaped yoke in this example, is connected to the bracket 72. The yoke 42 functions to couple the distal end 32 of the dielectric boom arm 16 to the work platform 18. As shown in FIG. 1, in a side-stowed orientation in which the dielectric boom arm 16 is offset to one side of the telescopic boom arm 14, the yoke 42 may be offset to the opposite side of the telescopic boom arm 14 so as to minimize torque occurring on the telescopic boom arm 14. This offset orientation of the boom assembly also facilitates stowing.

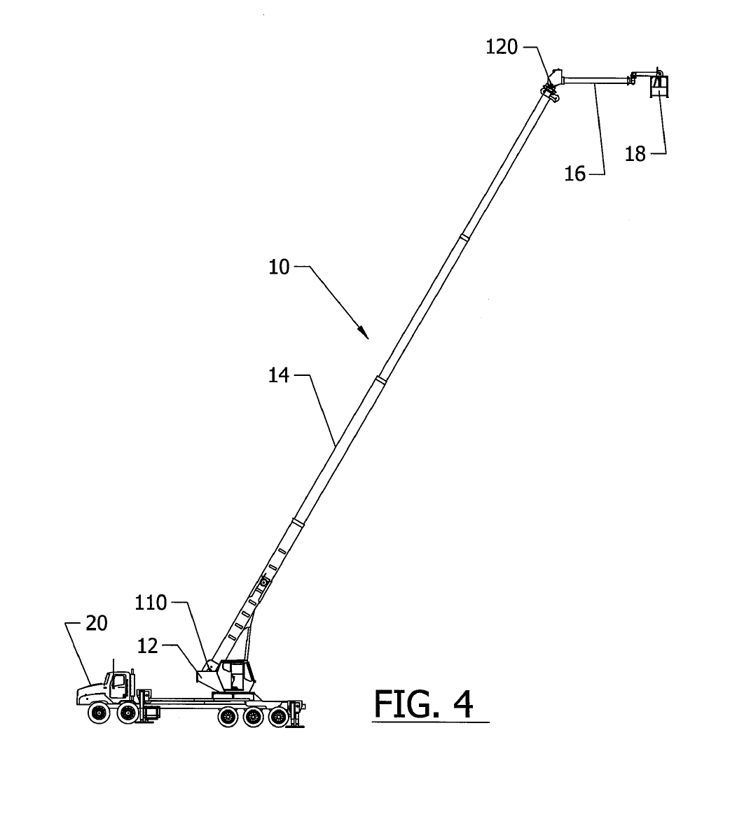

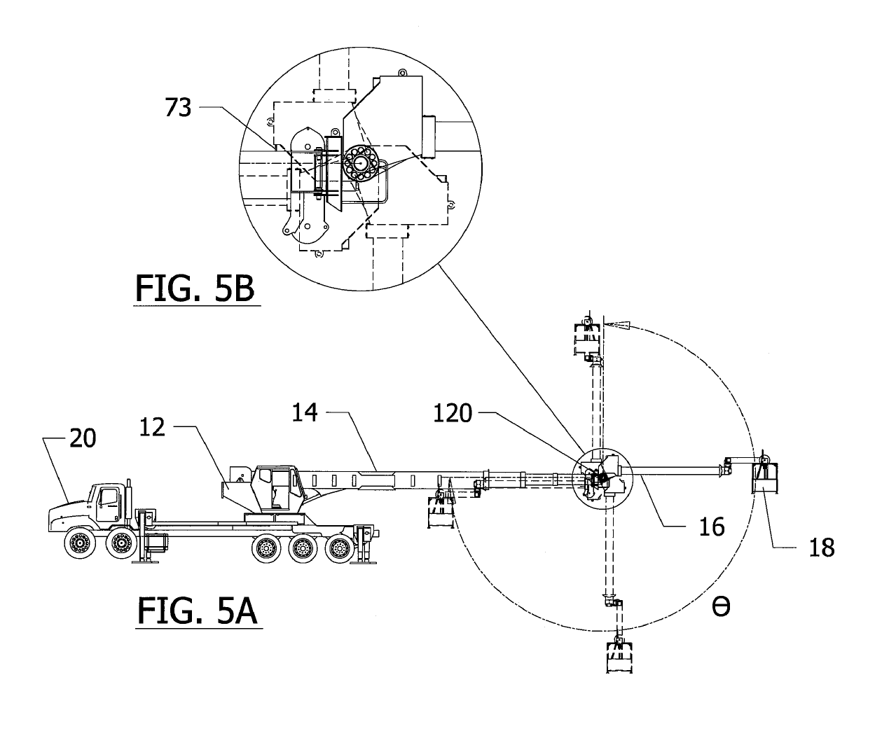

Referring back to FIG. 3, the work platform 18 is pivotably connected to the yoke 42 and is pivotable about a pivot axis 140 which is generally perpendicular to a longitudinal axis 150 of the dielectric boom arm 16. As shown in FIG. 4, this allows the work platform 18 to hang freely and level with the horizon as the telescopic boom arm 14 pivots through eighty degrees of articulation about its pivot axis 110 as well as when the dielectric boom arm 16 pivots through two hundred and seventy degrees of articulation about its pivot axis 120. Pivoting of the dielectric boom arm 16 from the side-stowed orientation through two hundred and seventy degrees is best shown in FIGS. 5A and 5B in which angle Θ is two hundred and seventy degrees. FIG. 5B shows a stop 73 which inhibits the dielectric boom arm 16 from pivoting past two hundred and seventy degrees from the stowed orientation, e.g. in a direction away from the stowed orientation beyond an upwardly extending vertical orientation. Referring once again back to FIG. 3, the work platform 18 is pivotably connected at its center to the yoke 42 to ensure proper gravity levelling. There is a brake mechanism in the form of disk brake 74 which has a manually operated caliper connected to the work platform 18. The disk brake 74 functions to lock the work platform 18 to inhibit tilting once the work platform 18 is positioned in a desired location. The disk brake 74 is independently operable and is independent of the hydraulic system 88 of the boom assembly 10 shown in FIGS. 8A to 8C. In this particular example the brake is independent of the hydraulic system since it is a mechanical brake. However it could be, for example, a hydraulic brake using a hydraulic system which is not connected to the hydraulic system 88 or could be operated electrically or pneumatically.

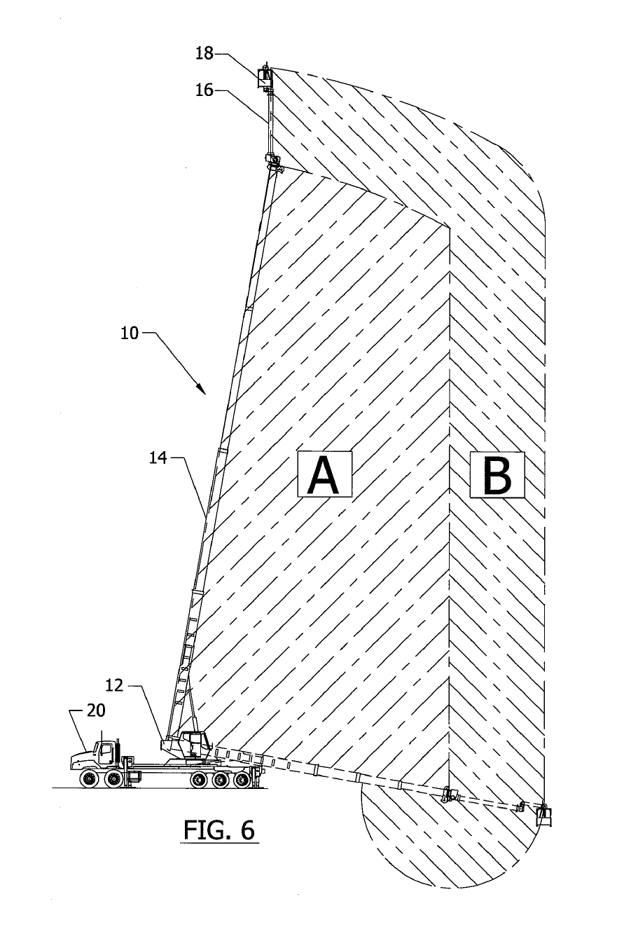

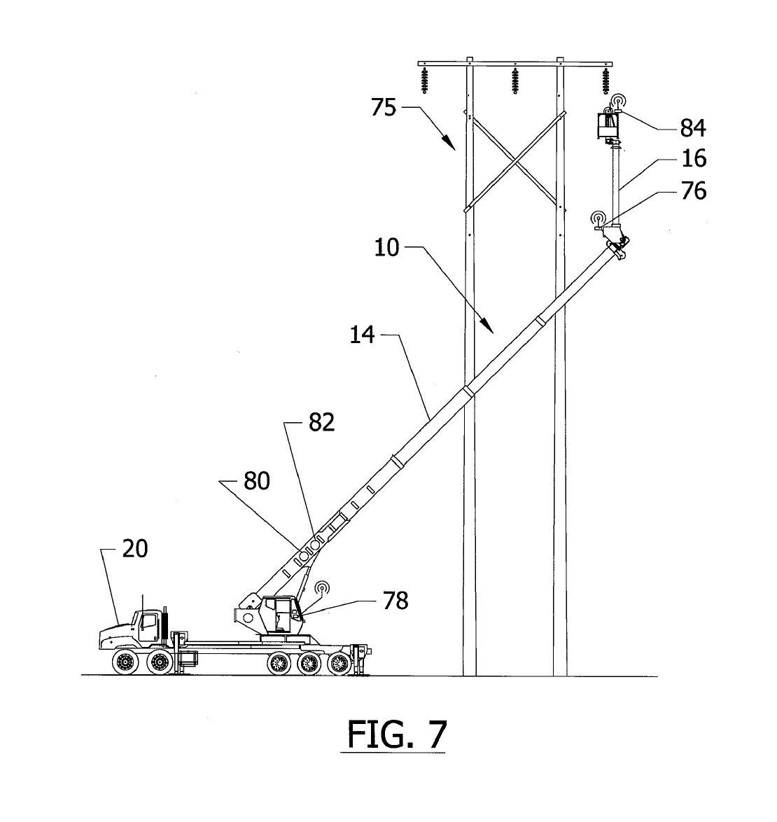

The ability of the dielectric boom arm 16 to pivot through two hundred and seventy degrees provides the boom assembly 10 with an improved range of motion as best shown in FIG. 6. Region A represents an operational range of motion of the telescopic boom arm 14 and region B represents an operational range of motion of the dielectric boom arm 16. As shown in FIG. 7, the improved range of motion allows the boom assembly 10 to be used to work on power lines 75 that might not otherwise be readily accessible when the telescopic boom arm 14 is fully extended. It is however important that the telescopic boom arm 14 and the dielectric boom arm 16 not move outside their operational range of motion shown in FIG. 6. In particular, it is important that the dielectric boom arm 16 not pivot, in a direction away from the stowed orientation, beyond the upwardly extending vertical orientation. Otherwise a reverse moment may be applied to the boom assembly 10.

The dielectric boom arm 16 is accordingly provided with a sensor for determining an angular position thereof. In this example, and as shown in FIG. 7, the sensor is in the form of a dielectric boom inclinometer 76 but may be any suitable sensor. The dielectric boom inclinometer 76 signals an angular position of the dielectric boom arm 16 to a controller 78. The telescopic boom arm 14 is also provided with a sensor in the form of a telescopic boom inclinometer 80 which signals an angular position of the telescopic boom arm 14 to the controller 78. The telescopic boom arm 14 is further provided with a sensor in the form of a distance sensor 82 which signals a length of the telescopic boom arm 14 to the controller 78. Wireless signals are used in this example although signals could be transmitted through conductors. Movement of the telescopic boom arm 14 and the dielectric boom arm 16 may be restricted by the controller 78, based on the relative positions of the telescopic boom arm and the dielectric boom arm, to prevent a reverse moment from being applied to the boom assembly 10 when an operator inputs a command using a control 84.

In this example, the controller 78 restricts movement of the telescopic boom arm 14 and the dielectric boom arm 16 by generating a signal to actuate dump valves 90, 92, 94 and 96, shown in FIGS. 8A to 8C, based on orientations of the telescopic boom arm 14 and the dielectric boom arm 16. FIGS. 8A to 8C illustrate the hydraulic system 88 of the boom assembly 10. The hydraulic system 88 of the boom assembly 10 is generally conventional with the exception of dump valves 90, 92, 94 and 96. In this example, the dump valves 90, 92, 94 and 96 are solenoid actuated, spring return valves which are biased to a closed position. A first dump valve 90 is connected along a hydraulic circuit 98 that supplies hydraulic fluid to the actuator 34 in order to pivot the telescopic boom arm 14 upward. A second dump valve 92 is connected along a hydraulic circuit 100 that supplies hydraulic fluid to the actuator 34 in order to pivot the telescopic boom arm 14 downward. A third dump valve 94 is connected along a hydraulic circuit 104 that supplies hydraulic fluid to an actuator 102 in order to extend the telescopic boom arm 14. A fourth dump valve 96 is connected along a hydraulic circuit 106 that supplies hydraulic fluid to the rotary actuator 38 in order to pivot the dielectric boom arm 16 in a direction away from the stowed orientation.

FIG. 8A shows the hydraulic system 88 of the boom assembly 10 when the dielectric boom arm 16 is not in the upwardly extending vertical orientation. The dump valves 90, 92, 94 and 96 remain in the closed position because movement of the dielectric boom arm 16 does not need to be restricted. However, when the dielectric boom inclinometer 76 signals the controller 78 that the dielectric boom arm 16 is in the upwardly extending vertical orientation, the controller 78, shown in FIG. 7, generates a signal to actuate the dump valves 90 and 96 to open positions as shown in FIG. 8B. The result is that hydraulic fluid being pumped to the actuator 34 to pivot the telescopic boom arm 14 upward is returned to the tank 108. Likewise, hydraulic fluid being pumped to the rotary actuator 38 to pivot the dielectric boom arm 16 in a direction away from the stowed orientation is returned to the tank 108. Accordingly, the telescopic boom arm 14 cannot be pivoted upward and the dielectric boom arm 16 cannot be pivoted in a direction away from the stowed orientation beyond the upwardly extending vertical orientation. This ensures that a reverse moment may be applied to the boom assembly 10.

Furthermore, when the telescopic boom inclinometer 80 and the distance sensor 82 signal the controller 78 that the telescopic boom arm 14 is at a maximum operating radius, the controller 78 generates a signal to actuate dump valves 92 and 94 to open positions as shown in FIG. 8C. The result is that hydraulic fluid being pumped to the actuator 34 to pivot the telescopic boom arm 14 downward is returned to the tank 108. Likewise, hydraulic fluid being pumped to the actuator 102 to extend the telescopic boom arm 14 is returned to the tank 108. Accordingly, the telescopic boom arm 14 cannot be pivoted downward or extended. This ensures that the maximum operating radius of the whole boom assembly 10 is not exceeded.

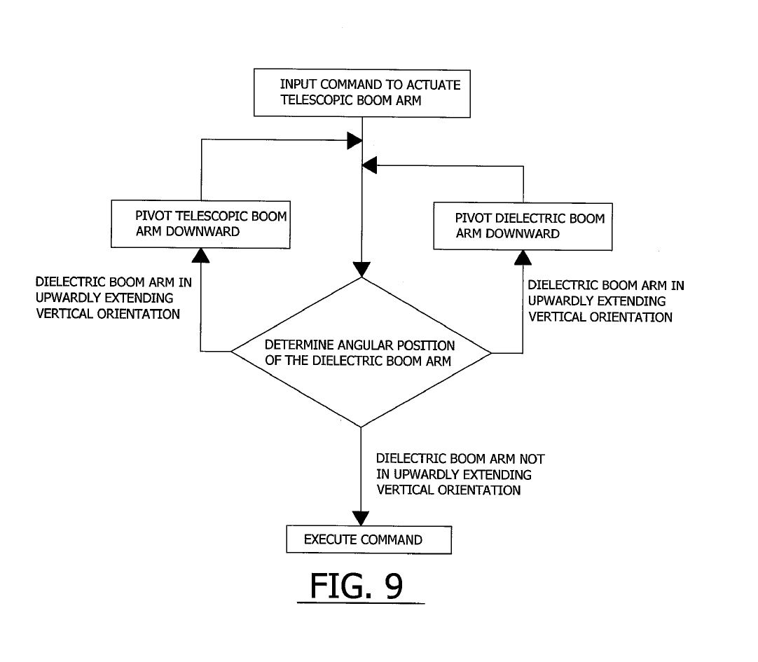

Referring now to FIG. 9, logic for actuating the telescopic boom arm 14 is shown. An inputted command to actuate the telescopic boom arm 14 is not executed until an angular position of the dielectric boom arm 16 is determined. If the dielectric boom arm 16 is not in the upwardly extending vertical orientation then the inputted command to actuate the telescopic boom arm 14 will be executed. This assumes that the telescopic boom arm 14 remains within its operating radius as is conventional and accomplished through use of known Hydraulic Overload Protection Systems and Electronic Capacity Alert Systems. However, if the dielectric boom arm 16 is in the upwardly extending vertical orientation, then the inputted command to actuate the telescopic boom arm 14 upward will not be executed until the dielectric boom arm 16 is pivoted downward in a direction towards the stowed orientation.

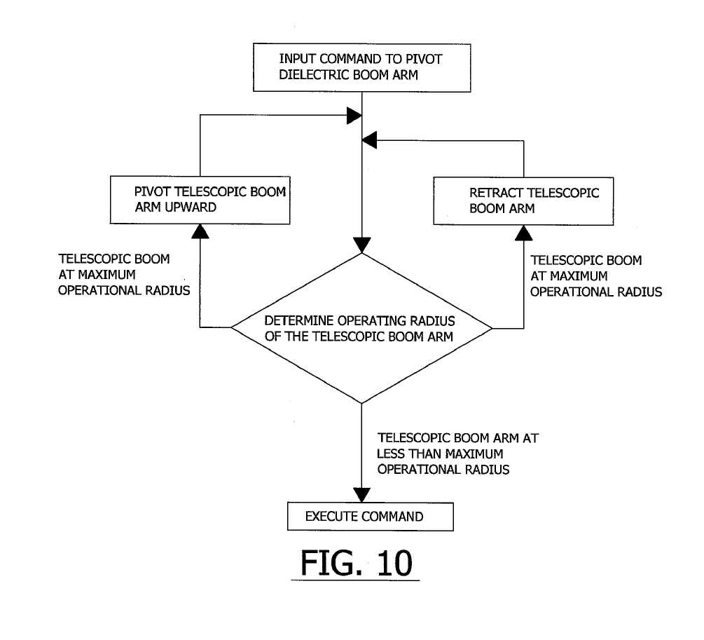

Referring now to FIG. 10, logic for pivoting the dielectric boom arm 16 is shown. An inputted command to actuate the dielectric boom arm 16 is not executed until an operating radius of the telescopic boom arm 14 is determined. If the telescopic boom arm 14 is at less than its maximum operating radius then the inputted command to pivot the dielectric boom arm 16 will be executed. This assumes that the dielectric boom arm 16 will not be pivoted in a direction away from the stowed orientation beyond the upwardly extending vertical orientation. However, if the telescopic boom arm 14 is at its maximum operating radius, then the inputted command to pivot the dielectric boom arm 16 will not be executed until the telescopic boom arm 14 is pivoted upward or retracted.

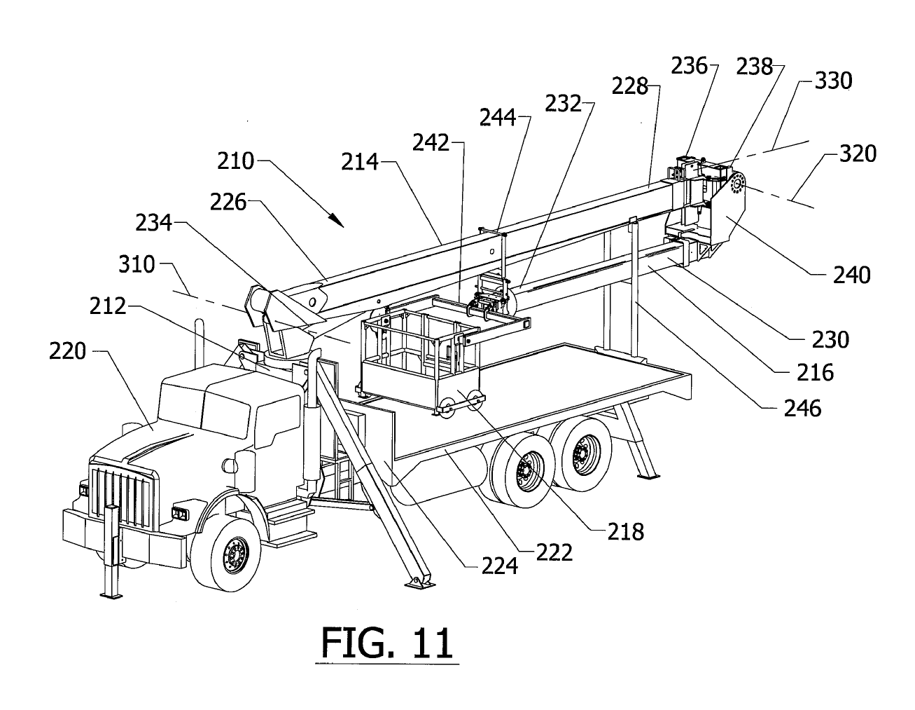

A second embodiment of a boom assembly 210 is shown in FIG. 11. The boom assembly generally includes a base 212, a first boom arm which in this example is a telescopic boom arm 214, a second boom arm which in this example is a dielectric boom arm 216, and a work platform 218 which may also be referred to as a work bucket. The boom assembly 210 is mounted on a vehicle 220 and, in particular, the base 212 of the boom assembly is mounted on a flatbed 222 of the vehicle near a front end 224 thereof. The boom assembly 210 is rotatably mounted to the vehicle 220 in this example. However, in other examples, the boom assembly may be fixedly mounted on the vehicle.

The telescopic boom arm 214 has a proximal end 226, which is proximal relative to the base 212, and a distal end 228 which is distal relative to the base 212. Likewise the dielectric boom arm 216 has a proximal end 230, which is proximal relative to the distal end 228 of the telescopic boom arm 214, and a distal end 232 which is distal relative to the distal end 228 of the telescopic boom arm 214. The proximal end 226 of the telescopic boom arm 214 is pivotably coupled to the base 212 in a conventional manner and there is an actuator 234 which functions to pivot the telescopic boom arm 214 about a pivot axis 310. Hydraulic extension cylinders and cables within the telescopic boom arm 214 move the telescopic boom arm between an extended position and a retracted position in a conventional manner. There is a bracket 236 mounted on the telescopic boom arm 214 at the distal end 228 thereof. The bracket 236 supports a rotary actuator 238 which, in this example, is in the form of a helical hydraulic rotary actuator. The proximal end 230 of the dielectric boom arm 216 is coupled to an output drive (not shown) of the rotary actuator 238 such that the dielectric boom arm is positioned substantially below the telescopic boom arm 214. The rotary actuator 238 imparts rotary motion to the dielectric boom arm 216 such that the dielectric boom arm is pivotable about a pivot axis 320 which is substantially perpendicular to a longitudinal axis 330 of the telescopic boom arm 214. The distal end 232 of the dielectric boom arm 216 is coupled to the work platform 218 by a yoke 242. A first support arm 244 and a second support arm 246 may be used to restrict movement of the dielectric boom arm 16 during transport.

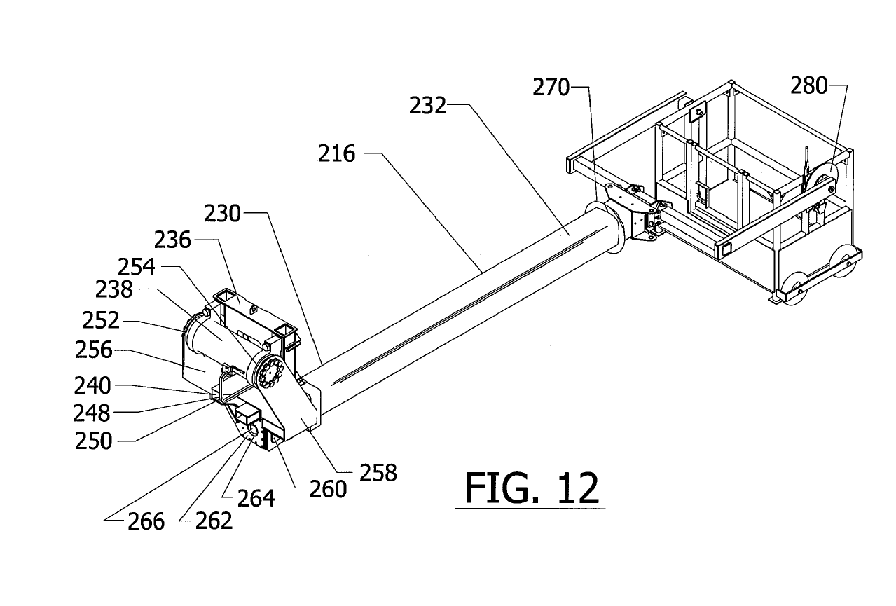

Referring now to FIG. 12, the rotary actuator 238 and a bracket 240 coupling the rotary actuator to the dielectric boom arm 216 is shown in greater detail. The rotary actuator 238 is independently controlled by pumping hydraulic fluid through hydraulic hoses 248 and 250. The hydraulic hoses 248 and 250 extend along the telescopic boom arm 214, shown in FIG. 11, when the telescopic boom arm is in the extended position. The hydraulic hoses 248 and 250 retract into retractable hose reels (not shown) when the telescopic boom arm 214 is in the retracted position. The hydraulic hoses 248 and 250 are also connected to a directional control valve (not shown) and then to a hydraulic pump or hydraulic tank on the vehicle 220 as is conventional.

The output drive of the rotary actuator 238 includes outer flanges 252 and 254 which are secured to corresponding flanges 256 and 258 of the bracket 240. The outer flanges 252 and 254 of the rotary actuator 238 impart motion to the bracket 240 and thereby impart motion to the dielectric boom arm 216. The bracket 240 also includes a socket 260 which is positioned substantially bellows the socket and receives the proximal end 230 of the dielectric boom arm 216. The socket 260 is provided with a window 262, of acrylic in this example, having an opening 264 for receiving a desiccant canister 266. The acrylic window 262 is releasably secured to the socket 260 by a bolted connection which compresses a gasket (not shown) to provide an environmentally resistant seal to inhibit ingress of dirt or moisture into an interior of the dielectric boom arm 216. The desiccant canister 266 may be releasably coupled to the acrylic window 262 by mechanical threading. The purpose of the desiccant canister 266 is to allow air inside the dielectric boom arm 216 to expand and compress as well as to remove moisture which may have entered the dielectric boom arm 216.

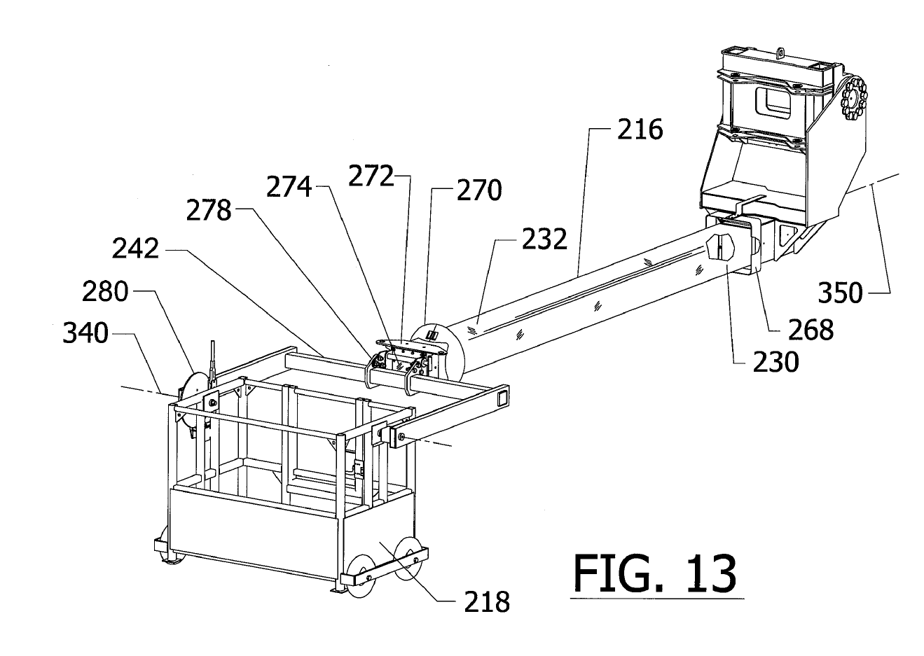

Referring now to FIG. 13, the dielectric boom arm 216 is dielectrically insulated from a conductive shield 268 at the proximal end 230 thereof to a gradient control device 270 at the distal end 232 thereof. The gradient control device 270 has a tapered cone shape with a sharp outer edge. The purpose of the gradient control device 270 is to restrict corona streamers from encroaching on an insulated portion of the dielectric boom arm 216. All conductive components mounted distally of the gradient control device 270 should be electrically bonded to the gradient control device but should not encroach on the gradient control device during operation of the dielectric boom arm 216.

There is a socket 272 at the distal end 232 of the dielectric boom arm 216. The socket 272 is provided with a window 274, of acrylic in this example, that is releasably secured to the socket 272 by a bolted connection which compresses a gasket (not shown) to provide an environmentally resistant seal. The acrylic window 274 allows for easy inspection of the interior of the dielectric boom arm 216. There is also a bracket 278 at the distal end 232 of the dielectric boom arm 216, where the bracket 278 couples to the socket 272. The yoke 242, which is a U-shaped yoke in this example, is connected to the bracket 278. The yoke 242 functions to couple the distal end 232 of the dielectric boom arm 216 to the work platform 218.

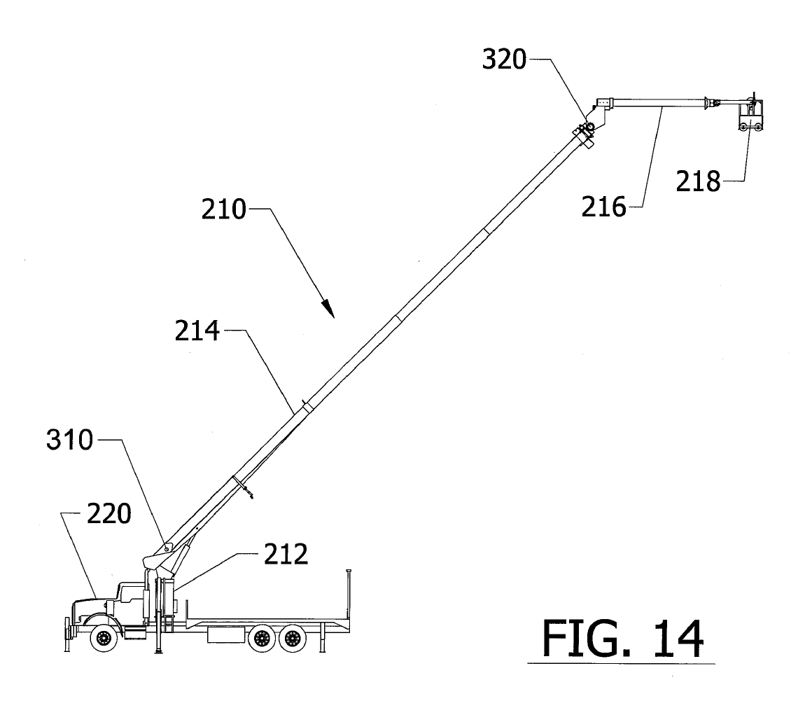

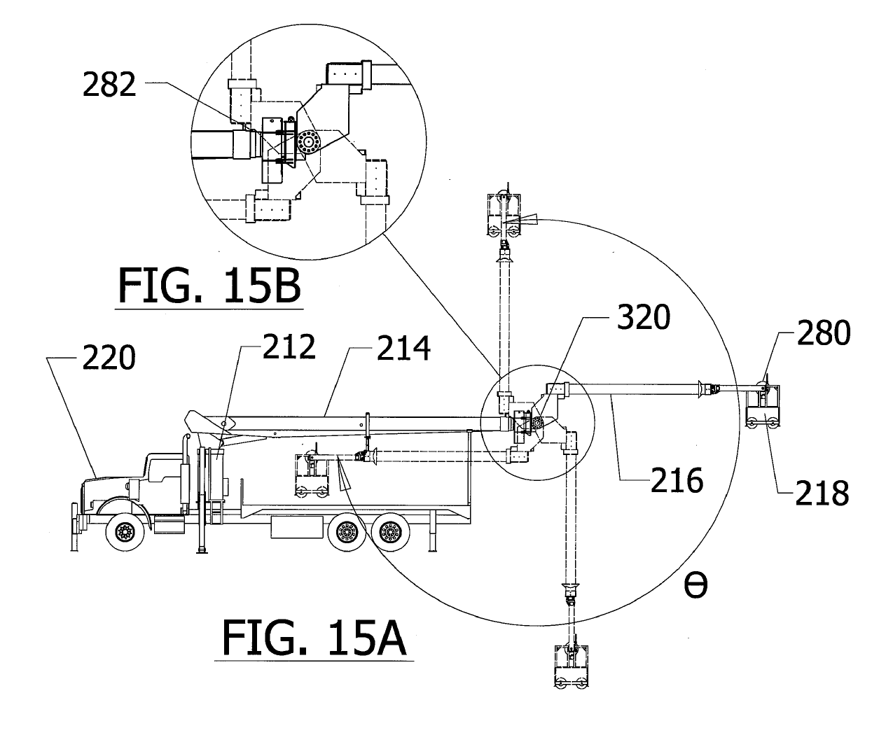

The work platform 218 is pivotably connected to the yoke 242 and is pivotable about a pivot axis 340 which is generally perpendicular to a longitudinal axis 350 of the dielectric boom arm 216. As shown in FIG. 14, this allows the work platform 218 to hang freely and level with the horizon as the telescopic boom arm 214 pivots through eighty degrees of articulation about its pivot axis 310 as well as when the dielectric boom arm 216 pivots through two hundred and seventy degrees of articulation about its pivot axis 320. Pivoting of the dielectric boom arm 216 from the stowed-under orientation through two hundred and seventy degrees is best shown in FIGS. 15A and 15B in which angle Θ is two hundred and seventy degrees. FIG. 15B shows a stop 282 which inhibits the dielectric boom arm 216 from pivoting past two hundred and seventy degrees from the stowed orientation, e.g. in a direction away from the stowed orientation beyond an upwardly extending vertical orientation. Referring back to FIG. 13, the work platform 218 is pivotably connected at its center to the yoke 242 to ensure proper gravity levelling. There is a brake mechanism in the form of disk brake 280 which has a manually operated caliper connected to the work platform 218. The disk brake 280 functions to lock the work platform 218 to inhibit tilting once the work platform 218 is positioned in a desired location. The disk brake 280 is independently operable and is independent of the rotary actuator 238.

The operational range of motion of the telescopic boom arm 214 and of the dielectric boom arm 216 is substantially identical to the range as shown for the first embodiment of the boom assembly 10 in FIG. 6. Likewise the electrical and hydraulic controls as well as the logic of the second embodiment of the boom assembly 210 are substantially identical to the first embodiment of the boom assembly 10 as shown in FIGS. 7 to 10.

It will be understood by a person skilled in the art that the dielectric boom arm and work platform together with the bracket and rotary actuator may be provided as an aftermarket accessory for an existing boom assembly.

It will further be understood by a person skilled in the art that many of the details provided above are by way of example only, and are not intended to limit the scope of the invention which is to be determined with reference to the following claims.

What is claimed is:

1. A hydraulic boom assembly comprising:
a base;
a first boom arm extending from the base;
a second boom arm pivotably coupled to the first boom arm;
a hydraulic system for actuating the first boom arm between an extended position and a retracted position, and for pivoting the second boom arm; and
a work platform coupled to the second boom arm, wherein the work platform is provided with a brake mechanism that is independent of the hydraulic system for actuating the first boom arm and pivoting the second boom arm.

2. The boom assembly as claimed in claim 1 wherein the second boom arm is a side-stowed, dielectric boom arm.

3. The boom assembly as claimed in claim 1 wherein the second boom arm is a stowed-under, dielectric boom arm.

4. The boom assembly as claimed in any one of claims 1 to 3 wherein the first boom arm is a telescopic boom arm.

5. The boom assembly as claimed in any one of claims 1 to 3 further including a hydraulic actuator near a proximal end of the second boom arm for pivoting the second boom arm relative to the first boom arm.

6. The boom assembly as claimed in any one of claims 1 to 5 wherein the second boom arm is pivotable between a stowed orientation through two hundred and seventy degrees to an upwardly extending vertical orientation when the first boom arm is horizontal.

7. The boom assembly as claimed in any one of claims 1 to 6 further including a stop for inhibiting the second boom arm from pivoting in a direction away from the stowed orientation beyond the upwardly extending vertical orientation.

8. The boom assembly as claimed in any one of claims 1 to 6 wherein the hydraulic system includes a dump valve connected along a hydraulic circuit that provides hydraulic fluid to an actuator to pivot the first boom arm upward, the dump valve being actuated to open when the second boom arm is in the upwardly extending vertical orientation and thereby inhibit the first boom arm from pivoting in a direction away from the stowed orientation beyond the upwardly extending vertical orientation.

9. The boom assembly as claimed in any one of claims 1 to 6 wherein the hydraulic system includes a dump valve connected along a hydraulic circuit that provides hydraulic fluid to an actuator to pivot the second boom arm in a direction away from the stowed orientation, the dump valve being actuated to open when the second boom arm is in the upwardly extending vertical orientation and thereby inhibit the second boom arm from pivoting in a direction away from the stowed orientation beyond the upwardly extending vertical orientation.

10. The boom assembly as claimed in any one of claims 1 to 6 wherein the hydraulic system includes a dump valve connected along a hydraulic circuit that provides hydraulic fluid to an actuator in order to pivot the first boom arm downward, the dump valve being actuated to open when the first boom arm is at a maximum operating radius and thereby inhibit the first boom arm from pivoting downward.

11. The boom assembly as claimed in any one of claims 1 to 6 wherein the hydraulic system includes a dump valve connected along a hydraulic circuit that provides hydraulic fluid to an actuator in order to extend the first boom arm, the dump valve being actuated to open when the first boom arm is at a maximum operating radius and thereby inhibit the first boom arm from extending.

12. A vehicle provided with a hydraulic boom assembly, the hydraulic boom assembly comprising:
a base;
a first boom arm extending from the base;
a second boom arm pivotably coupled to the first boom arm;
a hydraulic system for actuating the first boom arm between an extended position and a retracted position, and for pivoting the second boom arm; and
a work platform coupled to the second boom arm, wherein the work platform is provided with a brake mechanism that is independent of the hydraulic system for actuating the first boom arm and pivoting the second boom arm.

13. The hydraulic boom assembly as claimed in claim 12 wherein the second boom arm is a side-stowed, dielectric boom arm.

14. The hydraulic boom assembly as claimed in claim 12 wherein the second boom arm is a stowed-under, dielectric boom arm.

15. An attachment for a boom assembly comprising a first boom arm and a hydraulic system for actuating the first boom arm, the attachment comprising:
a dielectric boom arm pivotably couplable to the first boom arm;
a hydraulic actuator near a proximal end of the dielectric boom arm for pivoting the dielectric boom arm relative to the first boom arm, the hydraulic actuator being connectable to the hydraulic system for actuating the first boom arm; and
a work platform coupled to the dielectric boom arm, wherein the work platform is provided with a brake mechanism that is independent of the hydraulic actuator.
